(19) United States
(12) Patent Application Publication
(10) Pub. No.: US 2008/0262972 A1
(43) Pub. Date: Oct. 23, 2008

(54) Order confirmation devices, systems, and methods

(76) Inventor: Patrick J. Blake, Ft. Sheridan, IL (US)

Correspondence Address: BRINKS HOFER GILSON & LIONE, P.O. BOX 10395, CHICAGO, IL, 60610, US

(21) Appl. No.: 11/788,526

(22) Filed: Apr. 20, 2007

(51) Int. Cl. H04L 9/00

(52) U.S. Cl. 705/75

(57) ABSTRACT

Devices, systems, and methods for confirming online orders are provided. In some embodiments, a method of confirming an online food order is provided, where the method includes providing a confirmation device at a vendor facility, where the confirmation device is adapted to receive an order and send the order to a display or printing device; receiving an online order through the confirmation device; printing or displaying the order and an associated confirmation code; and entering the confirmation code into the confirmation device to confirm receipt of the order. The confirmation device may be dedicated to the single purpose of confirming online orders and may be incorporated into a point-of-sale device.

### BACKGROUND

1. Technical Field

The present invention relates to devices, systems, and methods for confirming electronic commerce orders, and more particularly, to devices, systems, and methods for confirming time-sensitive online orders, such as orders for pick up or delivery of food or other items.

2. Background Information

The increasing use of electronic media, such as the Internet, has expanded the opportunities for consumers to enjoy the convenience of placing orders for a vast array of goods and services from their homes. For example, consumers can order food, clothing, household items, electronics, event tickets, prescriptions, groceries, and numerous other goods and services by using a computer connected to the Internet.

The placement of online food orders is becoming increasingly popular. A restaurant or other food vendor may provide an online ordering service through its Internet site. Such services typically allow customers to view a menu, select the desired menu items, specify whether they wish to pick up the items or have them delivered, and pay for the selected items. Customers may also place online food orders through Internet sites such as www.ordernetwork.com, which allows a customer to select a desired restaurant or other food vendor, view menus, and place and pay for orders for pick up or delivery by the selected vendor.

Online ordering systems are convenient for both the customer and the vendor. However, to fully realize the benefits of online ordering, a prompt and accurate method of confirming receipt of an online order and assuring the customer that the requested order will be fulfilled by the vendor is needed.

Receipt by a vendor of an online order may be confirmed by an automated telephone call to the vendor requesting that the vendor enter information into the telephone to verify receipt of the order. However, such a method may not always be effective. For example, the telephone line may be busy when the call is placed; the call may be answered by an automated answering system; or the front desk at a restaurant may answer the call rather than the restaurant's carry-out or delivery location where the order was received. In such circumstances, an order can be delayed or interrupted.

Automated electronic mail messages to the customer may be used to confirm a vendor's receipt of, and intent to fulfill, an order. However, such messages may also fail to serve their intended purpose. For example, the confirmation message automatically sent to the customer may not accurately reflect whether the confirmed order is being fulfilled by the vendor if the vendor is out of a certain item and needs to substitute a different item for the out-of-stock item, or if the vendor reviews the order and decides not to take the credit risk of fulfilling it because the validity of the order is questionable and payment was to be made at the time of pick up or delivery. As a result, the customer may arrive at the vendor's location to pick up an order that is different from the order that was submitted online and confirmed by the automated email (for example, because the vendor substituted an in-stock item for an out-of-stock item specified in the customer's order), or the customer may arrive at the vendor's location and then be informed that additional time will be required to prepare the order (for example, because the vendor determined, after the order was automatically confirmed, that the order was not valid and thus should not be fulfilled). Similarly, an online order that is to be delivered to the customer may arrive at the customer's delivery location as an incomplete or otherwise incorrect order, or the order may not arrive at all, notwithstanding the customer's receipt of an automated message confirming the order as submitted.

Telephones or general purpose computers connected to the Internet may also be used to confirm online orders placed by customers. However, some vendors dislike the idea of using such general purpose equipment at their facilities for the purpose of confirming online orders because the equipment may also be used for unauthorized purposes, such as conversing with friends, browsing the Internet, and playing video games, thereby causing inefficiencies in employee productivity.

Accordingly, there is a need for improved devices, systems, and methods for promptly, accurately, and efficiently confirming receipt of online customer orders and/or informing customers of any deficiencies or errors in the receipt or fulfillment of such orders.

### BRIEF SUMMARY

The present invention provides devices, systems, and methods for promptly and accurately confirming receipt by a vendor of an online order and the vendor's intent to fulfill the order as submitted, or for addressing any order errors or deficiencies. In some embodiments of the present invention, a device dedicated to the single purpose of confirming orders is provided, where the device includes: a connection to the Internet for receiving an online order from a customer, where the connection may include, for example, a telephone line, cable line, or wireless modem in conjunction with the services of an Internet service provider; an input mechanism, such as a plurality of keys or buttons or a touch-sensitive screen; a processor; and an output mechanism for sending the online order to a display or printing device located at a vendor facility. In certain embodiments, the confirmation device may be incorporated into a point-of-sale device located at the vendor's facility.

In other embodiments of the present invention, an online order confirmation system is provided, where the system includes: a confirmation device dedicated to the single purpose of confirming orders, where the confirmation device is adapted to receive an online order from a customer, send the order to a display or printing device located at a vendor facility, and receive entry of a confirmation code by the vendor; a central processor capable of generating a confirmation code for the order; and a device for printing or displaying the order and the associated confirmation code. In certain embodiments, the confirmation code is a multi-character alpha-numeric code, whereas in other embodiments the confirmation code is a bar code, the substance of which may be entered into the confirmation system by means of a scanning device.

In still other embodiments of the present invention, a method of confirming an online order is provided, where the method involves: providing a confirmation device at a vendor facility, where the confirmation device is adapted to receive an online order and send the order to a display or printing device; receiving an online order through the confirmation device; printing or displaying the order and an associated confirmation code; and entering the confirmation code into the confirmation device to confirm receipt of the order. The method may also include the steps of generating and sending a confirmation message, such as an electronic mail message, to a customer after the vendor verifies the completeness and validity of the order. In certain embodiments, where the vendor is unable to verify the validity of an order, or where the vendor is unable to fulfill the order as submitted by the customer, the order may be routed to a customer service representative.

### BRIEF DESCRIPTION OF THE DRAWINGS

FIG. 1 is a flowchart illustrating one embodiment of an order confirmation system and method of the present invention;

FIG. 2 illustrates one embodiment of the order confirmation device of the present invention; and

FIG. 3 illustrates another embodiment of the present invention in which one embodiment of the order confirmation device is incorporated into a point-of-sale device; and

FIG. 4 is a flowchart illustrating one embodiment of a method of the present invention.

### DETAILED DESCRIPTION OF THE DRAWINGS AND THE PRESENTLY PREFERRED EMBODIMENTS

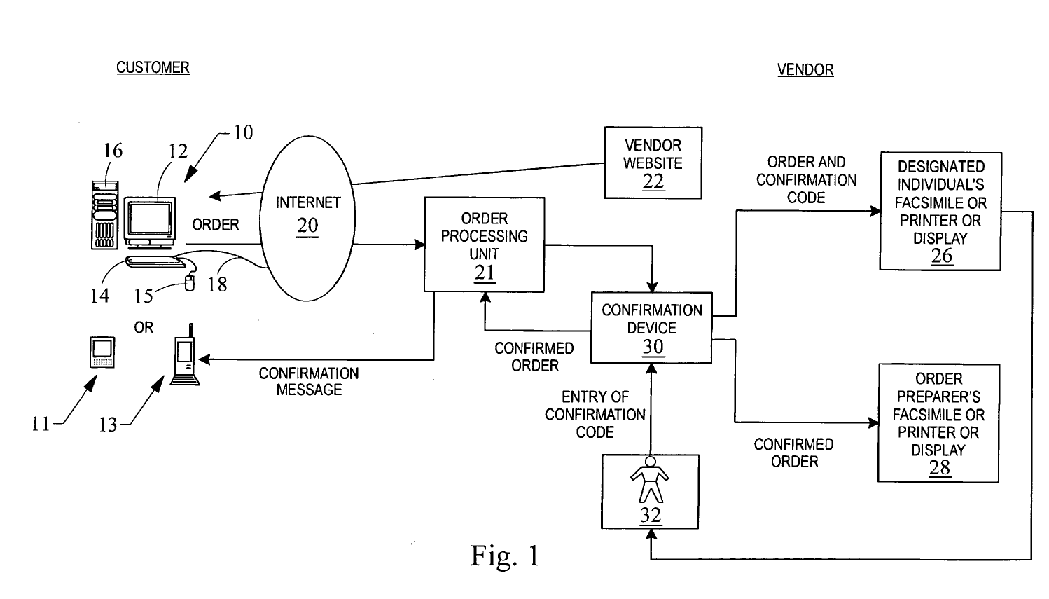

Turning now to the figures, FIG. 1 illustrates one embodiment of the confirmation system and method of the present invention. In this embodiment, a vendor makes available through the Internet 20 a listing of the goods and/or services offered for sale by the vendor. For example, a restaurant may make its menus available through an Internet website 22 having a user interface that permits customers to view the menu items offered by the restaurant, select desired items from the menu, submit an order for the desired items, specify whether the order is for pick up or delivery, and specify the desired method of payment for the order, such as cash (to be paid at the time of pick up or delivery), credit card, or debit card.

An Internet website having similar functionality may also be made available from a source other than the vendor itself. For example, Order Network hosts a website in which customers may view a listing of various restaurants in their area, select a desired restaurant, view a menu from the desired restaurant, place an order for desired menu items, specify whether the order is for pick up or delivery, and specify the method of payment.

As shown in FIG. 1, a customer may submit an online order for desired goods or services by using a laptop or desktop computer 10 having a connection 18 to the Internet 20; an input mechanism, such as a plurality of buttons or keys 14 (for example, a keyboard or keypad), mouse 15, or touch-sensitive screen 12; and a central processing unit 16. Alternatively, the customer may submit an online order using any other type of device having access to the Internet, such as a handheld computer 11 or telephone (cellular or landline) 13. The procedure for submitting an order may vary, depending on the website through which the order is placed. In some situations, the customer simply clicks a “submit” button on the vendor's website after entering his or her menu selections and other required ordering information to transmit the order to the vendor for processing and fulfillment.

In some embodiments of the present invention, after the order is submitted, it is transmitted to an order processing unit 21. The order processing unit 21, which includes a processor and a memory, may then generate a confirmation code for the order. Alternatively, the confirmation device 30 may generate the confirmation code. The confirmation code may be a randomly generated alpha-numeric code, a code incorporating various numbers, letters, and/or symbols indicative of certain characteristics of the order, a bar code, or any other type of code suitable for being associated with an order.

The order and associated confirmation code may then be transmitted by the order processing unit 21 to a confirmation device 30. In certain embodiments, the confirmation device 30 is located at the facility of a vendor and includes a connection to the Internet, processor, memory, display, input mechanism for entry of a confirmation code by the vendor, and output mechanism for sending the online order to a display or printing device. Any type of Internet connection may be used for purposes of the present invention. For example, a customer may connect to the Internet by utilizing a telephone line, cable modem, wireless modem, DSL connection, satellite connection, or any other type of suitable connection, in conjunction with the services of an Internet service provider.

Any type of processor, memory, display, input mechanism, or output mechanism may be used in the confirmation device 30 of the present invention. For example, a plurality of buttons, a keypad, a touch-sensitive screen, and/or a scanning device may be used as an input mechanism; and any computer program or other mechanism suitable for sending an order received by the confirmation device 30 to a display or printing device, such as a facsimile machine or a printer located at a vendor's facility, may be used as an output mechanism.

In certain embodiments of the present invention, after an order is sent to the confirmation device 30, it is sent to a facsimile machine, printer, or display 26. In some embodiments, a computer program or an outsourced facsimile service (such as DATA ON CALL) may be used to send the order to the facsimile machine, printer, or display 26. The printed or displayed order may contain a confirmation code in the form of a combination of letters, numbers, and/or symbols, or in the form of a bar code.

After the printed or displayed order is received by the vendor, the vendor may initiate a manual review of the order by a designated individual 32, such as a manager, supervisor, or other employee, to confirm that the entire order was transmitted successfully, that the vendor is able to fulfill the order as received, and that the order is a valid order (as opposed to an order that is suspicious because of the quantity of items ordered, the specified delivery location, and/or other questionable factors apparent from the order).

If the order is found to be valid, a designated individual 32 may then enter the confirmation code into the confirmation device 30 by any suitable input mechanism to confirm receipt of the order. In some embodiments of the present invention, the confirmation device 30 then initiates an automated telephone call to a call center service (such as VOICESHOT®), which converts the entered confirmation code into a form readable by the order processing unit 21. Upon recognizing that receipt of the order has been confirmed by the restaurant, the order processing unit 21 may then send a confirmation message to the customer to confirm receipt of the order and the vendor's intent to fulfill the order as received. Such a confirmation message may take any suitable form (such as an email, facsimile, text message, or telephone call) and may contain other information of importance to the customer (such as approximate times of delivery or pick up). In some embodiments of the invention, an order, once confirmed, may also be printed to a facsimile machine or printer, or displayed on a screen 28, in the kitchen of the vendor, for example, as shown in FIG. 1, so that preparation of the order can begin promptly.

If an error is discovered upon review of the order, a request may be initiated to retransmit the order to the order confirmation device and then to the display or printing device. Alternatively, the order may be routed to a customer service representative for handling. In some embodiments of the method of the present invention, the request to retransmit the order or the routing of the order to a customer service representative may be effected by depressing an appropriately designated button or key on the order confirmation device. In other embodiments, depressing a RESEND button multiple times results in the order being transferred to a customer service representative to address a recurrent problem with the order.

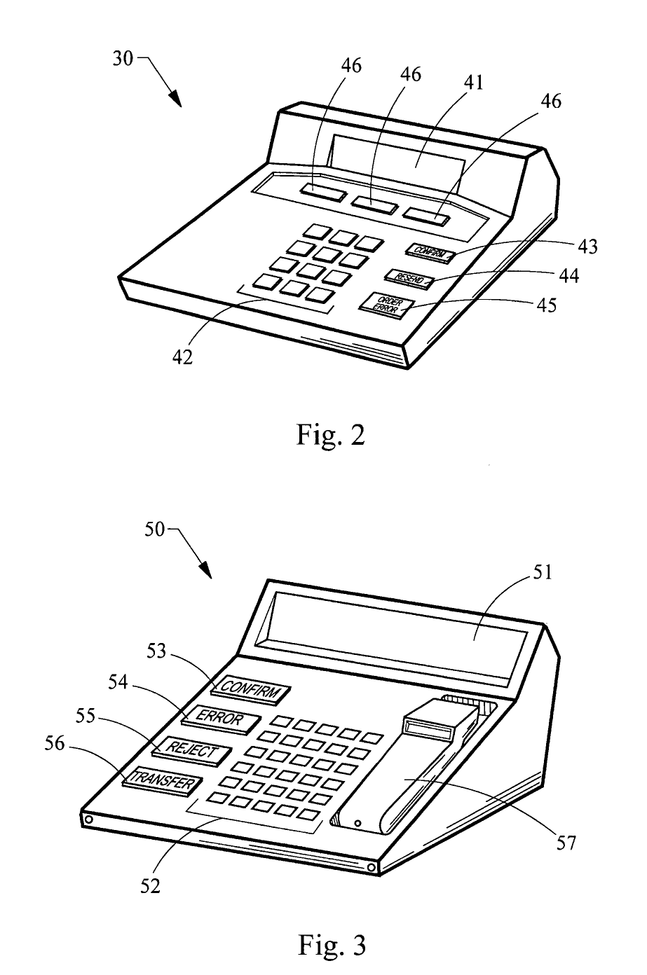

One exemplary embodiment of a confirmation device 30 of the present invention is illustrated in FIG. 2. In this embodiment, the confirmation device 30 includes a display 41, a plurality of numerical buttons 42, a plurality of buttons dedicated to specific functions 43, 44, 45, and a plurality of buttons corresponding to variable “soft” selection options 46 presented on the display 41. Any input mechanism suitable for entering confirmation information into the confirmation device 30 may be used. Many variations of the configuration shown in FIG. 2 are possible.

In the embodiment illustrated in FIG. 2, the confirmation device 30 has the following buttons dedicated to special functions: a CONFIRM button 43 for acknowledging that an order was received and will be fulfilled by the vendor; a RESEND button 44 for requesting that the customer or order confirmation unit resubmit the order; and an ORDER ERROR button 45 for notifying the customer that the order was not successfully transmitted to the vendor or that there is another problem with the order, and for routing the order to a customer service representative. The buttons 42, 43, 44, 45 of the confirmation device 30 may protrude from the surface of the confirmation device 30 or they may be flush with the surface, depending on the preferences of the user.

In certain embodiments, the confirmation device 30 of the present invention is dedicated to the single purpose of confirming orders. More specifically, in these embodiments, the confirmation device is a device other than a general purpose computer or telephone, for example. As such, the single-purpose confirmation device may prevent or minimize non-productive employee activities such as browsing the Internet or conversing with personal contacts through electronic mail or telephone conversations. In addition, because this embodiment of the confirmation device is dedicated to confirming orders, the concern of missing a confirmation request because of a busy telephone line (caused by the use of the telephone for other business-related activities, for example) is avoided.

In some embodiments, the confirmation device, which may be a single-purpose device, may be incorporated into a point-of-sale device located at the vendor's facility. In one exemplary embodiment of the present invention, a single-purpose confirmation device and a purchase processing device are combined into a single unit, as illustrated in FIG. 3.

In the embodiment illustrated in FIG. 3, the confirmation device is incorporated into a point-of-sale device 50. In this embodiment, the point-of-sale device includes a display 51, a plurality of buttons or keys containing various indicia thereon 52; and a plurality of buttons or keys dedicated to specific functions 53, 54, 55, 56, such as a CONFIRM button 53 for confirming receipt of the order, an ERROR button 54 for indicating that the order was not successfully received and requesting that the order be resent, a REJECT (or CANCEL) button 55 for declining orders that appear to be of questionable validity and/or for routing such orders to a customer service representative, and a TRANSFER button 56 for routing to a customer service representative orders that require follow up (for example, orders that the vendor is unable to fulfill due to a shortage in one of the specified menu items).

The embodiment shown in FIG. 3 also includes a scanning device 57. This scanning device 57 may be used to enter into the confirmation device a confirmation code in the form of a bar code. Moreover, in addition to confirming online orders by means of the single-purpose confirmation device incorporated into the combination unit 50 illustrated in FIG. 3, the unit 50 may also be used, for example, to process orders of customers who are physically present at the vendor's facility.

The intended purpose of the special function buttons or keys 43, 44, 45, 53, 54, 55, 56 illustrated in FIGS. 2 and 3 may be accomplished by triggering the intended action through the processor in the confirmation device 30 or point-of-sale device 50 or by triggering the intended action when the order is transmitted to an order processing unit 24, as shown in FIG. 1. For example, in certain embodiments, a computer program may be implemented in any of these devices to carry out the commands indicated on the face of the buttons.

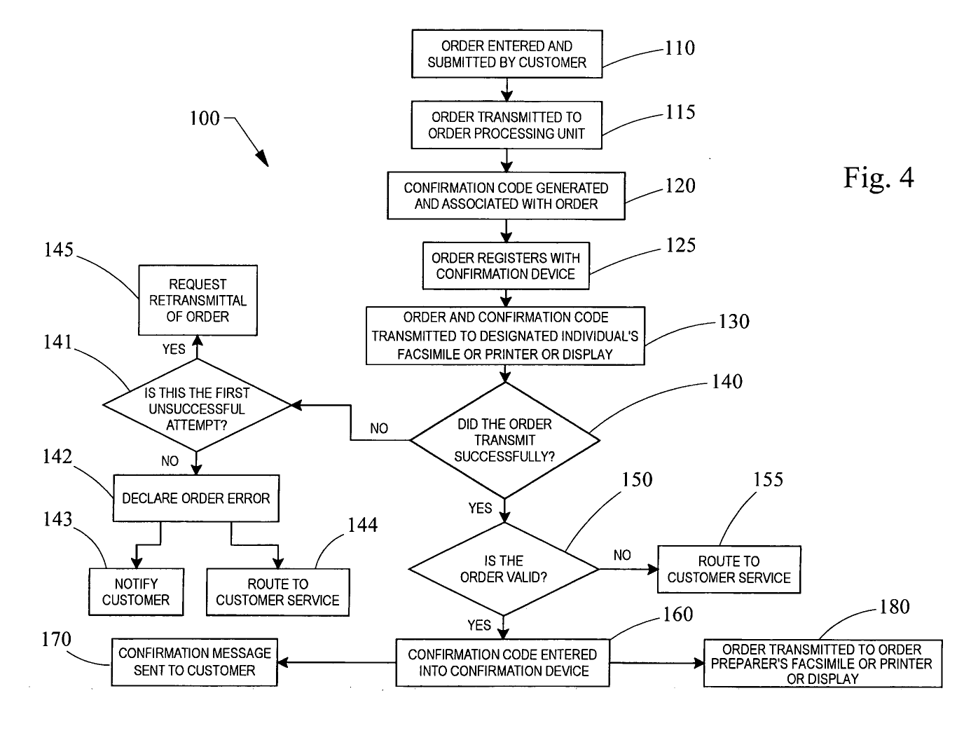

A flowchart of one embodiment of a method of the present invention is illustrated in FIG. 4. In this embodiment, a customer enters and submits an online order 110 through the Internet website of a vendor or through the Internet website of an intermediary that provides access to information for multiple vendors, for example. The order may then be transmitted to an order processing unit 115. The order processing unit may then generate a confirmation code and associate the confirmation code with the order 120. The order confirmation code may be generated in any suitable manner. For example, the confirmation code may be comprised of multiple alpha-numeric characters, symbols, and/or lines and may be generated randomly or by a predetermined program designed to take into account specific characteristics of the order.

Next, in the embodiment illustrated in FIG. 4, the order registers with an order confirmation device 125, and then the order and associated confirmation code are printed on a facsimile machine or other printing device, or are otherwise displayed in any suitable manner 130. Upon receipt of the printed or displayed order, an employee of the vendor, for example, determines whether the order was transmitted successfully 140. If the order transmission was incomplete, illegible, or otherwise deficient, the appropriate key, button, or display option on the order confirmation device may be activated to request that the order be retransmitted 145. In some embodiments of the invention, the confirmation code (if available) may be entered into the order confirmation device before selecting the appropriate key, button, or display option on the order confirmation device, to uniquely identify the order to which the request applies. The order may be resent from the order processing unit or from the customer, depending upon the source of the unsuccessful transmission and/or the specific configuration of the system. The specific processing procedure of an unsuccessful order transmission may vary, depending upon the wishes of the vendor. The order confirmation device and its associated functions may be adapted accordingly.

According to the embodiment of FIG. 4, if the order was transmitted successfully, the employee or other appropriate individual then determines whether the order is a valid order 150. For example, if the address on the order is not a valid street address, or if the order is for an inordinately large number of items for delivery to a residential address, the employee may wish to more fully investigate whether the order is legitimate before beginning to prepare the order, especially if the payment for the order is not to be received until the order is picked up or delivered.

If the order is found to be invalid or to require further investigation, the appropriate key, button, or display option on the order confirmation device may be activated to route the order to a customer service representative or other appropriate individual or system for further handling 155. In other embodiments, an initial electronic mail message, facsimile, or telephone call, for example, may be automatically generated and sent to the customer to begin the process of verifying the validity of the order.

In some embodiments of the method of the present invention, a second unsuccessful attempt at transmitting an order 141 may result in the order being routed to a customer service representative 144 and/or in a message being sent to the customer notifying the customer of the error 143. This notification message and/or rerouting of the order may be effected by depressing an ORDER ERROR button on the confirmation device 142, for example, or in any other suitable manner.

According to the embodiment of FIG. 4, if the order is found to be valid, an employee or other appropriate individual may then enter the confirmation code appearing on the printed or displayed order into the confirmation device 160, followed by activation of a CONFIRM key, button, or display option, for example. A confirmation electronic mail message may then be automatically generated and sent to the customer 170 to confirm that the order was successfully received and that the vendor will prepare the order. The confirmation message may also include other information such as vendor advertisements and/or the approximate time of delivery or pick up, for example.

In the embodiment illustrated in FIG. 4, after the order is confirmed, the order is printed or displayed in the kitchen or other area of order preparation 180. This step may occur before, during, or after transmission of a confirmation message to the customer. By printing or displaying the order at the location of preparation only after the order has been confirmed, a vendor may permit supervisory employees, for example, rather than employees in the area of order preparation, to make the decisions regarding the successful transmission of and validity of the order submitted by the customer. This sequence of events prevents premature preparation of a deficient order.

Although examples have been provided regarding the application of the disclosed inventions to online food orders from restaurants or other food vendors, additional applications are contemplated by the present invention. For example, the present invention may apply to orders of prescriptions, groceries, event tickets, clothing, household items, electronics, or any other type of order.

It is therefore intended that the foregoing detailed description be regarded as illustrative rather than limiting, and that it be understood that it is the following claims, including all equivalents, that are intended to define the spirit and scope of this invention.

What is claimed is:

1. A method of confirming an online food order, the method comprising:
providing a confirmation device dedicated to confirming online orders, wherein the confirmation device is adapted to receive the order and send the order to a display or printing device;
receiving the order through the confirmation device;
printing or displaying the order with a confirmation code; and
entering the confirmation code into the confirmation device to confirm receipt of the order.

2. The method of claim 1 wherein the confirmation device is located at a vendor facility.

3. The method of claim 1 wherein the confirmation device is incorporated into a point-of-sale device.

4. The method of claim 3 wherein entering the confirmation code comprises using a bar code scanner, touch-sensitive screen, or buttons associated with the point-of-sale device.

5. The method of claim 1 further comprising determining whether the order is valid before entering the confirmation code.

6. The method of claim 5 wherein determining whether the order is valid comprises manually reviewing the order.

7. The method of claim 6 further comprising referring the order to a customer service representative when the order is determined to be invalid.

8. The method of claim 6 further comprising generating and sending a confirmation message to a customer when the order is determined to be valid.

9. The method of claim 8 further comprising printing or displaying the order at a location where the order is to be prepared.

10. The method of claim 1 wherein the confirmation device is connected to a telephone line.

11. An online order confirmation system comprising:
a confirmation device adapted to receive an online order from a customer, send the order to a display or printing device located at a vendor facility, and receive input of a confirmation code, wherein the confirmation device is dedicated to confirming orders;
an order processing unit for generating a confirmation code for the order; and
a device for printing or displaying the order and the confirmation code;
wherein the confirmation device comprises an input mechanism for entering a confirmation code, and wherein the confirmation device is incorporated into a point-of-sale device.

12. The confirmation system of claim 11 wherein the device for printing or displaying the order comprises a printer or a facsimile machine.

13. The confirmation system of claim 11 wherein the confirmation system is adapted to generate and send a confirming message to the customer.

14. The confirmation system of claim 13 wherein the system is adapted to send the confirming message after entry of the confirmation code into the confirmation device.

15. An online order confirmation device comprising:
a connection to the Internet for receiving an online order from a customer;
an input mechanism for entering a confirmation code;
a processor; and
an output mechanism for sending the online order to a display or printing device located at a vendor facility;
wherein the confirmation device is dedicated to confirming orders.

16. The confirmation device of claim 15 wherein the vendor facility comprises a restaurant.

17. The confirmation device of claim 16 wherein the confirmation device is incorporated into a point-of-sale device at the vendor facility.

18. The confirmation device of claim 16 wherein the confirmation code comprises a bar code.

19. The confirmation device of claim 16 further comprising a button for routing the order to a customer service representative.

20. The confirmation device of claim 16 further comprising a confirm button, a resend button, and an error button.
